(19) United States
(12) Patent Application Publication
(10) Pub. No.: US 2012/0265450 A1
(43) Pub. Date: Oct. 18, 2012

(54) METHOD FOR INSPECTING CORROSION UNDER INSULATION

(75) Inventors: Hidehiko Suetsugu, Niihama-shi (JP); Hisakazu Mori, Niihama-shi (JP); Toyokazu Tada, Niihama-shi (JP); Yuichi Machijima, Kita-ku (JP)

(73) Assignee: SUMITOMO CHEMICAL COMPANY, LIMITED, Tokyo (JP)

(21) Appl. No.: 13/500,260

(22) PCT Filed: Oct. 1, 2010
(86) PCT No.: PCT/JP2010/067696

§ 371 Date: Jun. 29, 2012

(30) Foreign Application Priority Data
Oct. 9, 2009 (JP) 2009-235031

(51) Int. Cl. G01N 29/12; G06F 19/00

(52) U.S. Cl. 702/34

(57) ABSTRACT

A method for inspecting corrosion under insulation simply and precisely at a low cost is provided. The method for inspecting CUI is characterized by obtaining signals from a fiber optical Doppler sensor attached to equipment and counting a waveform for a predetermined time before and after a point where an amplitude is over a threshold value as one acoustic emission (AE) signal, recording the AE signals and the maximum amplitudes thereof, subjecting the AE signals to a filtering process to remove noise signals, determining a frequency distribution of the AE signal hits relative to various maximum amplitude values, determining a regression line of the number of the AE hits relative to the maximum amplitudes from a scattering diagram which is obtained by double logarithmic expression of the frequency distribution, and judging existence or nonexistence of the corrosion based on a gradient of the regression line.

### TECHNICAL FIELD

The present invention is related to a method for inspecting corrosion under insulation in equipment. Specifically, the present invention is related to a method for inspecting under insulation which enables the corrosion to be inspected simply and precisely at a lower cost in the equipment which is covered with the insulation.

### BACKGROUND ART

Since the corrosion under insulation in the equipment made of carbon steel or low-alloy steel is a main cause of leakage trouble, the corrosion under insulation is one of serious degradation phenomena that are to be monitored in chemical plants that have been operated for years.

In general, many apparatuses such as towers and vessels, valves and plugs and a heat exchanger are covered with the insulations in chemical plants and so on.

The insulation is required to be removed in order that the corrosion under insulation (hereafter referred to as “CUI”) is inspected visually. Further, when scaffolding is made in order to disassemble (remove) the insulation, thousands of man-hours (a long period of time) and a large cost are required.

For example, a total length of pipes in one plant is very long such as several tens of kilometers in one plant, but the corrosion in pipes is found in two to three systems of a thousand (1000) systems. Therefore, there is a problem of extremely bad efficiency.

For this reason, there is a strong demand for development of CUI inspection techniques (for the piping) which do not require the removal operation of the insulation and is applicable to the plant equipment for which explosion-proof is often required.

Various nondestructive inspection techniques have been developed so as to be applied to the CUI inspection of the piping. For example, a radiation transmission method and an ultrasonic flaw detection method using a guide wave have been developed and performed.

The radiation transmission method is a test method wherein a radiation source and a sensor which is placed being opposed to the source are used and existence or nonexistence of damage of pipes is evaluated by determining a transmission intensity of the radiation which passes through the insulation and the pipes. Further, a pipe wall corrosion thinning map can be obtained by scanning the pipe its axis direction using a scanner provided with the radiation source and the sensor. The radiation transmission method makes it possible to figure out the corrosion state visually without removal of the insulation from the pipes (Non-patent Literature 1). The ultrasonic flaw detection method is a test method wherein the guide wave (the ultrasonic) is propagated in the pipe for a long distance and existence or nonexistence of damage in pipes is evaluated by determining echo which reflects on a site where a cross-sectional area is changed. This ultrasonic flaw detection method has a characteristic that the inspection for a long distance can be made since the guide wave is propagated in the pipe, and enables the state of the piping to be inspected at a high speed (Non-patent Literature 2).

### Prior Art Literature

Non-patent Literature 1: Hidetoshi KAWABE, “Corrosion Inspection Technique for Piping, Automatic Inspection of Petroleum Piping using RT, Real Time Radiography, Thru-VU”, Inspection Engineering, JAPAN INDUSTRIAL PUBLISHING CO., LTD., January 2006, pp. 18-24

Non-patent Literature 2: Yoshiaki NAGASHIMA, Masao ENDO, Masahiro MIKI, Kazuhiko MANIWA, “Pipe Wall Thinning Inspection Technique Using Guide Wave”, The Piping Engineering, JAPAN INDUSTRIAL PUBLISHING CO., June 2008, pp. 19-24

### DISCLOSURE OF INVENTION

However, the problem of the prior art inspection methods is that they are applicable to limited conditions.

Specifically, the scanner is attached to the pipe and the scanning along the axis direction of the pipe is required in order to obtain, for example, the corrosion thinning map for the entire piping when the radio transmission method is employed. Therefore, this can be applied only to the straight pipe portion of the piping. Further, another problem of the method is that the sites to which this method can be applied are limited in the piping wherein a distance between the pipes is small and the pipes have complicated shapes (such as in the chemical plant) since a space is necessary for installing a system such as the scanner provided with the radiation source and the sensor.

On the other hand, the ultrasonic flaw detection method is capable of detecting the flaw in a long distance such as several meters since the guide wave is propagated for a long distance in the piping. However, the echo appears not only in the site where the corrosive thinning occurs in the piping, but also in the site where the cross-sectional area is changed, such as a welded portion or a flange portion in the piping. For this reason, it is necessary to previously know the shape of the piping in order to precisely evaluate existence or nonexistence of the flaw in the piping. Further, the intensities of echo from the welded portion and the flange potion are strong, which results in a problem of occurrence of region(s) where the detection is not possible due to ringing of echo. Furthermore, the problem of this method is that the insulation is required to be removed from the piping in order to carry out the inspection.

The above problems are not only found in the piping, but also in the valves and plugs and the heat exchanger.

The present invention has been made under this situation and the object of the present invention is to realize a method for inspecting the corrosion under insulation which makes it possible to inspect the corrosion simply and precisely at a lower cost in the equipment covered with the insulation.

The present inventors intensively studied, in consideration of the above problems, the method for inspecting the corrosion under insulation which method makes it possible to inspect the corrosion simply, precisely and economically in the equipment to which the insulation is attached. As a result, the present inventors focused on the fact that an acoustic emission (hereinafter, which may be referred to as “AE”) which is an elastic wave is generated from flaking or crack at a corroded portion (hereinafter, the corroded portion may be referred to as “corrosion tubercle”) and found that the existence of the corrosion can be detected by detecting the AE using a fiber optical Doppler sensor, whereby the present invention has been completed.

The present invention is a method for inspecting corrosion under insulation in equipment covered with an insulation, which is characterized by:

obtaining signals from a fiber optical Doppler sensor attached to the equipment and counting a waveform for a predetermined time before and after a point at which an amplitude is over a threshold value, as one acoustic emission signal (AE signal),

recording the acoustic emission signals and the maximum amplitudes of the acoustic emission signals,

subjecting the acoustic emission signals to a filtering process to remove noise signals,

determining a frequency distribution of the number of the sequentially obtained acoustic emission signal hits (AE hits) relative to various maximum amplitude values,

determining a regression line of the number of the acoustic emission hits relative to the maximum amplitudes from a scattering diagram which is obtained by double logarithmic expression of the frequency distribution, and

determining existence or nonexistence of the corrosion in the equipment based on a gradient of the regression line.

The method for inspecting corrosion under insulation according to the present invention gives an effect of inspecting the corrosion simply and precisely at a lower cost since the fiber optical Doppler sensor is attached to the equipment to inspect the corrosion in the equipment.

### BRIEF DESCRIPTION OF DRAWINGS

FIG. 1 is a block diagram indicating a Doppler effect of an optical fiber.

FIG. 2 is a block diagram showing a Laser Doppler Interferometry.

FIG. 3 is a view showing an example of an AE waveform from a signal from a FOD sensor.

FIG. 4 is a view showing the number of AE hits per 30 minutes in Example 1.

FIG. 5 is a view showing a frequency distribution of AE hits relative to maximum amplitude values.

FIG. 6 is a view showing a scattering diagram obtained by double logarithmic expression of the frequency distributions obtained in Examples, and regression lines.

FIG. 7 is another view showing the number of AE hits per 30 minutes in Example 1 after the corrosion is removed.

FIG. 8 is a view showing a frequency distribution of AE hits relative to maximum amplitude values in Example 2.

FIG. 9 is a cross-sectional view showing schematically a mock-up piping used in example of the present invention.

### EMBODIMENTS FOR CARRYING OUT THE INVENTION

In the present invention, the “equipment” includes towers and vessels, piping, valves and plugs and a heat exchanger and so on to which the insulation is attached, that is, towers and vessels, piping, valves and plugs and a heat exchanger and so on which are covered with the insulation.

In the method for inspecting corrosion under insulation according to the present invention, a fiber optical Doppler sensor (FOD sensor) is attached to a surface of the equipment, one AE signal is established for an obtained signal, the AE signal and the maximum amplitude thereof are recorded, the noise AE signals are removed, a frequency distribution of the resultant number of the AE hits relative to various maximum amplitude values is determined, a regression line of the AE hits relative to the maximum amplitudes is determined from a scattering diagram obtained by double logarithmic expression of the frequency distribution, and existence or nonexistence of the corrosion is determined based on a gradient of the regression line.

The site of the equipment to which the FOD sensor is attached is not particularly limited, as long as the site is one where the FOD sensor can keep contact with the surface of the equipment, that is the surface of the equipment (e.g. the pipe at the site).

A method for attaching the FOD sensor to the equipment is not limited to a particular one, as long as the FOD sensor can keep contact with the surface of the equipment. The FOD sensor is attached using an attachment member or a commercially available contact medium. As the “commercially available contact medium”, Sony Coat (Tradename: made by Saan Gas Nichigo Corporation) which is commercially available as a medium for the ultrasonic flaw detection and an adhesive Aronalpha (Tradename: made by Konishi Co., Ltd.) can be exemplified. Further, the FOD sensor may be attached to the equipment before attaching the insulation when building a chemical plant, or it may be attached to the equipment in an existing chemical plant.

The time when the FOD sensor is attached may be any time before conducting the method for inspecting the corrosion under insulation. Since the durability of the FOD sensor is very high, it is preferable that the FOD sensor is always (that is, constantly or not-temporarily) installed in the equipment from the viewpoints of reducing the man-hours and the cost for disassembling the insulation.

Two or more the FOD sensors are preferably installed in the equipment so that the inspection of corrosion under insulation can be conducted efficiently in the equipment which extends over a wide area or for a long distance. The number of the FOD sensors attached to the equipment is not limited as long as the FOD sensor receives the AE successfully and the number may be selected optimally depending on the size (or width) or the length of the equipment which is an objective of the inspection. For example, the number of the FOD sensors may be selected considering the sensitivity of the FOD sensors such that any corrosion in the equipment can be detected.

Here, the FOD sensor and the AE detection method which are employed in the method for inspecting corrosion under insulation according to the present invention are described in detail below.

### [1. FOD Sensor]

The FOD sensor is a sensor which utilizes a Doppler effect of an optical fiber, and can detect strain (elastic wave or change in stress caused by the strain) which is applied to the optical fiber by reading a modulation (or change) in frequency of a light entering into the optical fiber.

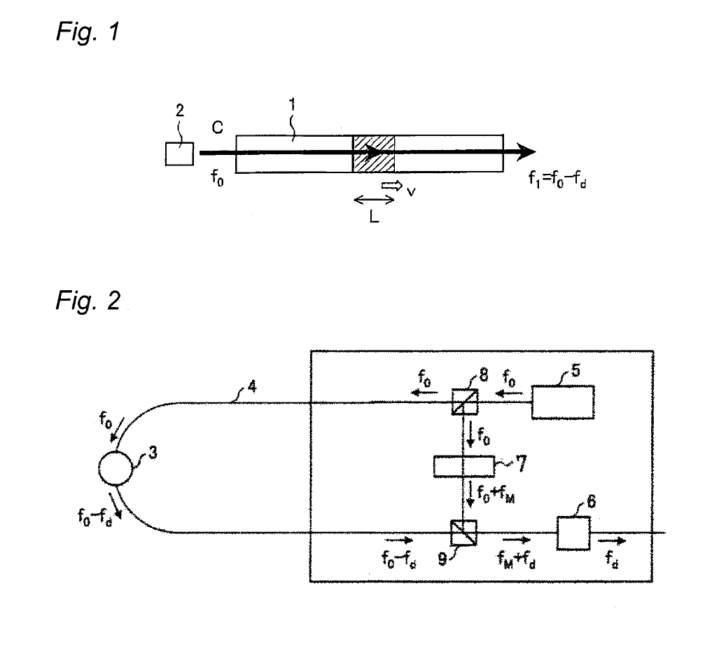

Here, the above-mentioned “Doppler effect” is described with reference to FIG. 1.

FIG. 1 is a block diagram for explaining the Doppler effect of the optical fiber. For example, when a light wave having an acoustic velocity C and a frequency f₀ is entered into the optical fiber 1 from a light source 2, the optical fiber 1 is elongated by a length L at an elongation speed v. Assuming that the frequency of the incident light is modulated from f₀ to f₁ by the Doppler effect, the frequency f₁ after the modulation can be expressed using a formula of the Doppler effect, as a formula (1).

$${f}_{1} = \frac{C - v}{C} {f}_{0} = {f}_{0} - \frac{v}{C} \cdot {f}_{0} \qquad ( 1 )$$

wherein, f₀ is a frequency of an incident light, f₁ is a frequency after modulation, C is an acoustic velocity and v is an elongation speed of the optical fiber.

Assuming that the frequency of the incident light is modulated from the frequency f₀ by f_{d} and becomes the frequency f₁ after the modulation, an amount of frequency modulation f_{d} of the optical fiber is expressed as a formula (2).

$${f}_{d} = {f}_{0} \cdot \frac{v}{C} \qquad ( 2 )$$

wherein f₀ is a frequency of an incident light, f_{d} is an amount of frequency modulation of an optical fiber, C is an acoustic velocity and v is a elongation speed of the optical fiber.

Further, when a formula of wave indicated by a formula (3) is used, the amount of frequency modulation f_{d} of the optical fiber can be expressed as a formula (4).

C=f₀·λ (3)

wherein f₀ is a frequency, C is an acoustic velocity and λ is a wavelength.

$${f}_{d} = {f}_{0} \cdot \frac{v}{C} = \frac{{f}_{0}}{C} \cdot v = \frac{1}{λ} \cdot \frac{d L}{d t} \qquad ( 4 )$$

wherein f₀ is a frequency of an incident light, f₁ is a frequency after modulation, C is an acoustic velocity, t is a time, L is a length of an optical fiber, and dL/dt is a change in length of the optical fiber over time.

Formula (4) indicates that the elongation and contraction speed of the optical fiber can be detected as the amount of frequency modulation of the light wave. In other words, the strain (elastic wave, change in stress and so on) which is applied to the optical fiber can be detected by reading the amount of frequency modulation f_{d} of the optical fiber.

Further, when the FOD sensor is constructed such that the optical fiber is stacked (or piled) by being wound into a coil, the sensitivity of the sensor can be improved due to a large value of L in the formula (4) and the sensor can receive the signals in all directions.

### [2. AE Detection Method]

A Laser Doppler Interferometry provided with the FOD sensor is used for detecting the AE. Thus, the Laser Doppler Interferometry provided with the FOD sensor is described with reference to a block diagram of FIG. 2. The Laser Doppler Interferometry is mainly provided with, in addition to the FOD sensor 3, an optical fiber 4 which is connected to the FOD sensor 3, a light source 5 which inputs an input light into the optical fiber 4, and a detector 6 which detects the amount of frequency modulation between an output light from the optical fiber 4 and the input light from the light source 5.

The light source 5 is a laser which utilizes a semiconductor, a gas or the like, and is adapted to input a laser beam (a coherent light) as the input light into the optical fiber 4. A wavelength of the input light from the light source 5 is not limited to a particular one, and may be of (or within) a visible light range or a infrared region. The semiconductor laser of which wavelength is 1550 nm is preferable since it is easily available.

The detector 6 can detect the amount of frequency modulation between the output light from the optical fiber 4 and the input light from the light source 5, and is preferably of a low-noise type capable of detecting the acoustic emission.

The Laser Doppler Interferometry is further provided with an AOM 7 (Acoustic Optical Modulator), a half mirror 8 which delivers a portion of the input light to AOM 7 and a half mirror 9 which delivers the input light modulated by the AOM 7 to the detector 6. The AOM 7 is of a conventional construction and adapted to modulate the frequency f₀ of the input light to a frequency (f₀+fₘ) (wherein f_{M} is an amount of change in frequency and may be a positive value or a negative value).

When the FOD sensor 3 receives the AE which occurs due to flaking or cracking caused by the corrosion in the equipment, the optical wave having a frequency of f₀ which is entered into the FOD sensor 3 from the optical source 5 via the optical fiber 4 is modulated to the frequency “f₀-f_{d}”. The modulated optical wave is input into the detector 6 via the optical fiber 4. In the detector 6, a modulation component (the amount of frequency modulation of the optical fiber) f_{d} is detected by an optical heterodyne interferometry. The detected modulation component f_{d} is converted to a voltage V by a FV converter (not shown) and is output from the Laser Doppler Interferometry. The frequency of the output signal is from about 10 kHz to about 250 kHz.

The output signal from the Laser Doppler Interferometry is recorded in a recording and analysis device in which the data processing and analysis are conducted.

In the present invention, existence or nonexistence of the corrosion is determined based on the number of the AE hits relative to the maximum amplitude values of the AE signals.

For the signal obtained from the FOD sensor, a waveform for a predetermined time including predetermined times before and after a point when the amplitude is over the threshold value (a trigger point) is counted as one (or a single) AE signal, and a waveform number (a file number) is assigned to this signal. This number is sequentially recorded together with the maximum amplitude of the waveform. About ±300 mV is selected as the threshold value, about 500 μs is selected as a time before the trigger point and about 1500 μs is selected as a time after the trigger point and therefore about 2000 μs is selected as a total time for recording the waveform, but not limited thereto. In general, the threshold value is selected based on a base noise which is peculiar to the optical fiber AE sensor. The time (period) for which one AE signal is recorded is selected so that the waveform of the AE signal can be easily recognized. This time may be decided experimentally.

The signals obtained from the FOD sensor include, in addition to the AE due to the corrosion, the AE caused by the vibration of equipment (environmental noise) which may affect the detection of the corrosion. For this reason, the recording and analysis device conducts data-processing to separate this environmental noise.

Firstly, the filtering process is conducted. With respect to the waveform amplitudes before and after the trigger point, the root mean square (RMS) values expressed by the formula (5) are determined respectively.

$${X}_{RMS} = \sqrt{\frac{1}{N} {\sum }_{i = 1}^{N} {X}_{i}^{2}} = \sqrt{\frac{{X}_{1}^{2} + {X}_{2}^{2} + ⋯ + {X}_{N}^{2}}{N}} \qquad ( 5 )$$

wherein the X₁, . . . , X_{N} are the respective amplitudes of a waveform and N is the number thereof.

“N” is the number of the amplitudes before (or after) the trigger point which amplitudes are used for determining the RMS value. “N” is selected so that a reliable RMS value is determined and is generally from 100 to 1000 or more (for example, about 2000).

The waveform wherein the ratio of the RMS value before the trigger point to the RMS value after the trigger point is a predetermined value or less is removed as the AE signal which is a noise (hereinafter, this is referred to as a “RMS processing”). The ratio of the RMS values is selected optimally considering the degree of removal of the noise. The ratio is suitably 1:2. In other words, when (the RMS value before the trigger point)/(the RMS value before the trigger point) is 2 or less, the signal may be regarded as the noise.

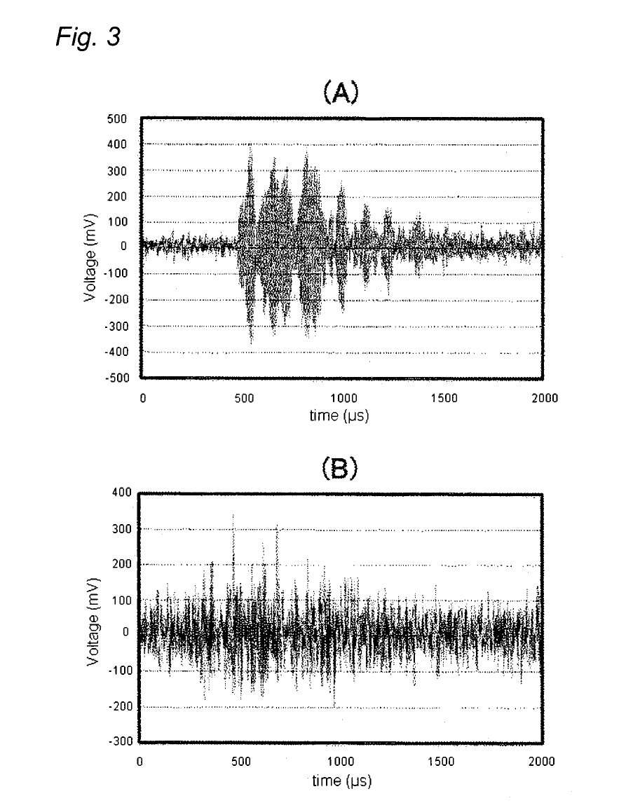

An example of the recorded one AE signal is shown in FIG. 3. An amplitude over ±300 mV exist at a position of 500 μs (the trigger point), and the waveform for 500 μs before the trigger point and for 1500 ps after the trigger point, that is, for 2000 ps in total is recorded.

The AE signal shown in FIG. 3(A) is remained after the RMS processing, while the AE signal shown in FIG. 3(B) is removed as the AE signal which is noise by the RMS processing.

Next, the frequency distribution of the number of the obtained AE signals (the AE hits) relative to various maximum amplitude values is determined. The range of the maximum amplitude value and the class (the width of the class) of the maximum amplitude is optimally and evenly selected so that the recorded maximum amplitudes are included.

The regression line of the AE hits relative to the maximum amplitude values is determined from the scattering diagram obtained by double logarithmic expression of the frequency distribution. The scattering diagram is a diagram wherein the both axes of the frequency distribution are indicated by logarithm expression and log (AE hits) is plotted to the log (maximum frequency value). The regression line is determined by the least-square method.

Existence or nonexistence of the corrosion in the equipment is determined or evaluated based on the gradient of this regression line. For example, when the gradient is larger (that is, steeper relative to the horizontal axis (an X axis) of the diagram) than about −2, that is, in a clockwise direction from about −2, determination that the corrosion exists can be made, in general. In other words, when an absolute value of the gradient value is larger than 2, the determination that the corrosion exists is made.

A particular gradient value used for determining the existence of corrosion may be determined experimentally. Therefore, the particular gradient value may be other than “−2”.

However, as long as the present inventors have studied, the value “−2” can be used as the particular gradient value for various types of equipment.

### EXAMPLES

The method for inspecting CUI is described by examples, but the present invention is not limited to these examples. The following devices were used.

(1) FOD Sensor:

A commercially available coiled FOD sensor (made by Lazoc Inc., LA-ED-S 65-07-ML) produced by coiling the optical fiber AE having a gauge length of 65 mm into a stacked coil.

(2) Laser Doppler Interferometry:

FOD interferometer (made by Lazoc Inc., LA-IF-15-06-C4-FC).

Frequency to be measured: 5 Hz to 1 MHz.

The light source wavelength: 1550 nm semiconductor laser.

(3) Recording and Analysis Device:

Recording device (made by Showadenki Corporation, SAS-6000).

### Example 1

An insulation was removed from an air oxidation reactor (an inner diameter of 3.8 m) within which a fluid was moved, and four FOD sensors (ch1 to ch4) were attached in a circumference direction with 90° pitches. The coat on an exterior surface was removed by a sand paper and the FOD sensors were attached to the exterior surface with a heat-resistant epoxy resin-based adhesive and fixed using an aluminum tape which was affixed on the FOD sensors.

The corrosion having an area of about 320 mm×about 90 mm and a depth of about 0.3 mm to about 0.5 mm was found about 2.5 m above the FOD sensor of ch1. The corrosion was not found within 4 m from the FOD sensor of ch2. The corrosion having an area of about 350 mm×about 65 mm and a depth of about 0.3 mm to about 1.0 mm was found about 2.5 m above the FOD sensor of ch3 and the corrosion having an area of about 720 mm×about 110 mm and a depth of about 0.3 mm to about 0.6 mm was found at a position which was in the distance of about 2 m from and lower right relative to the FOD sensor of ch3. The corrosion having an area of about 100 mm×about 50 mm and a depth of about 0.3 mm was found at a position which was in the distance of about 1.5 m from and lower right relative to the FOD sensor of ch4.

For the signal from the FOD sensor of which amplitude was over the threshold value (+/−300 mV), the waveform 500 μs before the trigger point and 1500 μs after the trigger point, that is, the waveform for the total 2000 μs was regarded as one AE signal.

Next, the root mean square values (RMS values) were determined for the wave shapes before the trigger point and after the trigger point respectively, and the waveform having the ratio of the RMS value before the trigger point to the RMS value after the trigger point was 1:2 or lower was removed as the noise AE signal.

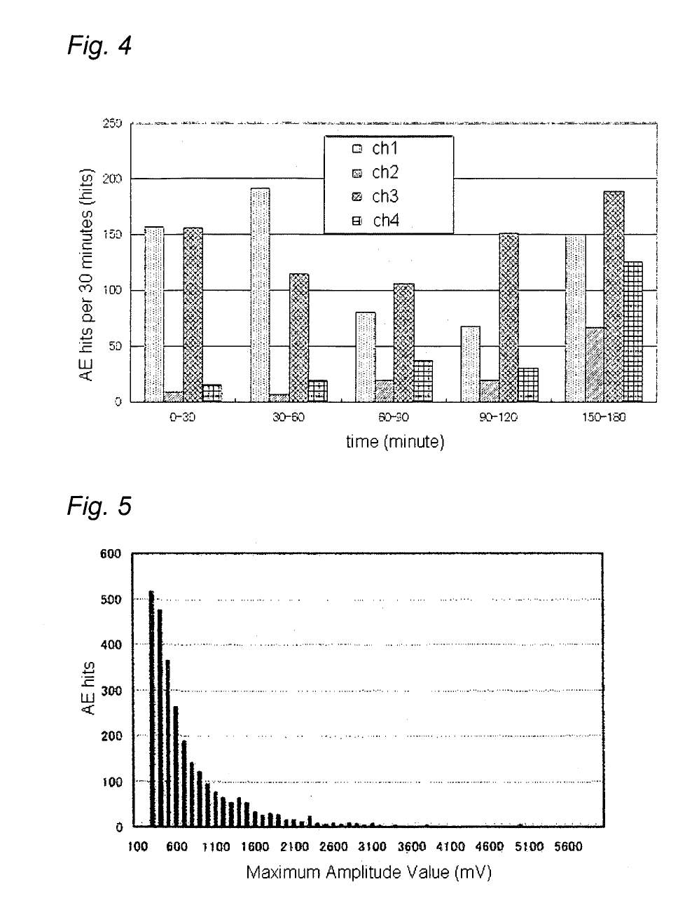

The sequentially obtained AE hits for the respective FOD sensors with 30 minute intervals were shown in FIG. 4. When the corrosion existed near the FOD sensor, the AE hits were large.

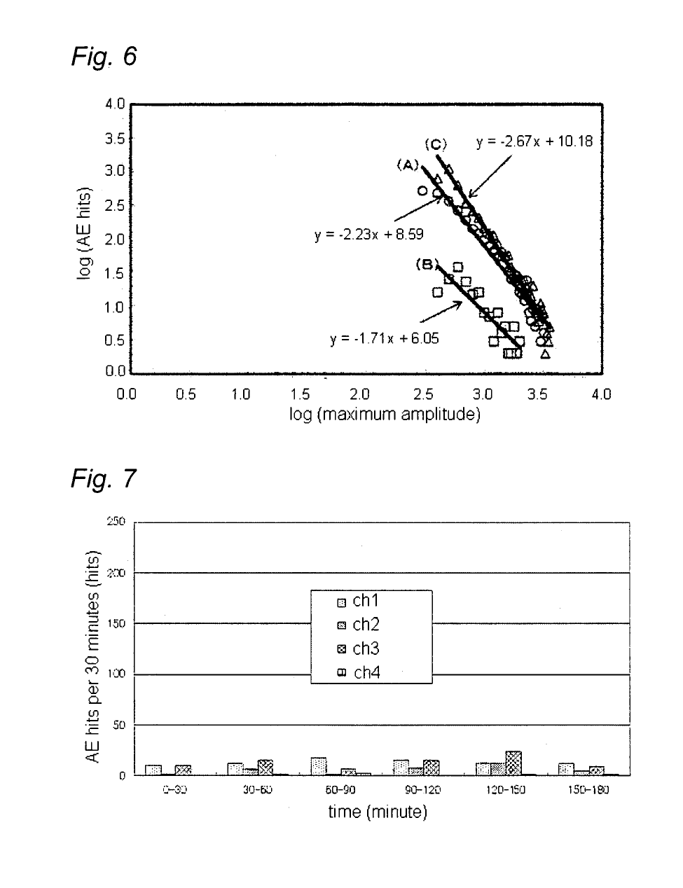

Further, the frequency distribution of the total AE hits obtained from the FOD sensors of ch1 to ch4 during 3 hours relative to various maximum amplitude values was determined (FIG. 5). The scattering diagram obtained by double logarithmic expression of this frequency distribution was shown in FIG. 6.

The regression line of the AE hits to the maximum amplitude values was determined from the data of the scattering diagram by the least-square method. This line (A) is expressed by the formula (6) and the gradient thereof is −2.23.

y=−2.23x+8.59 (6)

wherein y is log (AE hits) and x is log (maximum amplitude value).

Then, all the corrosion (rust) occurring in the equipment was removed by cleaning operation and the signals from the FOD sensors were processed in the same manner as described above.

The sequentially obtained AE hits with 30 minute intervals for the respective FOD sensors were shown in FIG. 7. When the corrosion does not exist, the AE is detected. However, the number of the AE hits is significantly reduced compared to the case where the corrosion exists.

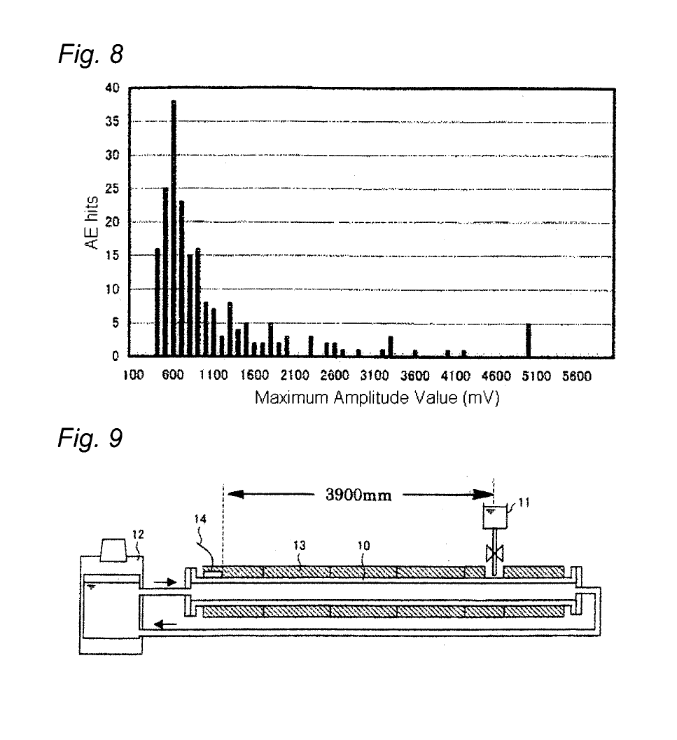

Further, the frequency distribution of the AE hits obtained during 3 hours relative to various maximum amplitude values was determined (FIG. 8). The scattering diagram obtained by double logarithmic expression of this frequency distribution was shown in FIG. 6.

The regression line of the AE hits to the maximum amplitude values was determined from the data of the scattering diagram by the least-square method. This line (B) is expressed by the formula (7) and the gradient thereof is −1.71.

y=−1.71x+6.05 (7)

wherein y is log (AE hits) and x is log (maximum amplitude value).

### Example 2

A mock-up piping was prepared as shown in FIG. 9.

An insulation 13 was attached to a carbon steel pipe 10 having an entire length of 5 m and a silicone oil which was heated by a heater 12 was circulated through the pipe 10. Further, corrosion was artificially accelerated in order to generate CUI efficiently. Specifically, pure water was continuously dropped from a dropping device 11 to a surface of the pipe 10 in such a dropping amount that was finely adjusted to produce a wet state and a dry state alternately. In addition, common salt was applied to the surface of the pipe 10. Further, the silicone oil circulating through the pipe 10 was heated in a range of 60° C. to 70° C., in order to accelerate the corrosions artificially.

The FOD sensor 14 was fixed by using a U-shaped bolt about one month after the start of the artificial acceleration of corrosion.

The silicone oil was heated 3 hours after the start of the AE determination, so that an oil temperature was raised. 3 Hours later, when the oil temperature reached to 70° C., the oil temperature was kept at 70° C. for 16 hours and then the heating of the silicone oil was stopped to reduce the oil temperature to a room temperature. It should be noted that the “oil temperature” was defined as a temperature indicated at the heater 12 for heating the silicone oil. Further, the circulation of the silicone oil through, the pipe 10 was continued during the determination of the AE hits regardless of whether the silicone oil was heated or not heated. In this example, the counting of the AE hits was conducted for 28 hours.

The signals from the FOD sensor were processed in the same manner as in Example 1, and the frequency distribution of the obtained AE hits relative to various maximum amplitude values was determined. The scattering diagram obtained by double logarithmic expression of the frequency distribution was shown in FIG. 6. The regression line of the AE hits to the maximum amplitude values was determined from the data of the scattering diagram by the least-square method. This line (C) is expressed by the formula (8) and the gradient is −2.67.

y=−2.67x+10.18 (8)

wherein y is log (AE hits) and x is log (maximum amplitude value).

From the results of Examples, the gradient of the regression line is lager than −2 when the corrosion exist and the gradient is less than −2 when the corrosion does not exist.

### INDUSTRIAL APPLICABILITY

The method for inspecting corrosion under insulation according to the present invention makes it possible to detect the corrosion under the insulation simply and precisely at a lower cost. The cost required for disassembling the insulation upon the maintenance and the check-up can be significantly reduced since the corrosion inspection can be made without removal of the insulation. The FOD sensor can be always installed not only in a chemical plant which has large-scale equipment, but also in a plant having an explosion-proof area, such as a petrochemical plant, since the FOD sensor has explosion proof and durability.

Therefore, the present invention can be suitably utilized in various industries which require the inspection of corrosion under insulation in the equipment.

### DESCRIPTION OF REFERENCE NUMERAL

1 Optical fiber

2 Light source

3 Fiber optical Doppler sensor (FOD sensor)

4 Optical fiber

5 Light source

6 Detector

7 AOM

8 Half mirror

9 Half mirror

10 Pipe

11 Dropping Device

12 Heater

13 Insulation

14 Fiber optical Doppler sensor (FOD sensor)

1. A method for inspecting corrosion under insulation in equipment covered with an insulation, which is characterized by:
obtaining signals from a fiber optical Doppler sensor attached to the equipment and counting a waveform for a predetermined time before and after a point at which an amplitude is over a threshold value, as one acoustic emission signal,
recording the acoustic emission signals and the maximum amplitudes of the acoustic emission signals,
subjecting the acoustic emission signals to a filtering process to remove noise acoustic signals,
determining a frequency distribution of the number of the sequentially obtained acoustic emission signal hits relative to various maximum amplitude values,
determining a regression line of the number of the acoustic emission hits relative to the maximum amplitudes from a scattering diagram which is obtained by double logarithmic expression of the frequency distribution, and
determining existence or nonexistence of the corrosion in the equipment based on a gradient of the regression line.

2. The method for inspecting corrosion under insulation according to claim 1, which is characterized in that the threshold value is +/−300 mV and the waveform 500 μs before the point at which the amplitude over the threshold value is obtained and 1500 μs after the point is counted as said one acoustic emission signal.

3. The method for inspecting corrosion under insulation according to claim 1, which is characterized in that the filtering process is made by determining root mean square values of waveform amplitudes before and after the point at which the amplitude over the threshold value is obtained, and removing, as the noise acoustic signal, the waveform having a ratio of the root mean square value before the point to the root mean square value after the point is predetermined value or less.

4. The method for inspecting corrosion under insulation according to claim 3, wherein the predetermined value of the ratio of the root mean square value before the point to the root mean square value after the point is 1:2.

5. The method for inspecting corrosion under insulation according to claim 1, which is characterized in that when the gradient of the regression line is larger than −2, the determination that the corrosion exists is made.
